(19) United States
(12) Patent Application Publication
(10) Pub. No.: US 2006/0218844 A1
(43) Pub. Date: Oct. 5, 2006

(54) Universal fishingpole holder for a deck, lawn or any tubular chair

(75) Inventors: Sharon Marie Oliver, Elizabeth, CO (US); Charles Henry Oliver JR., Elizabeth, CO (US)

Correspondence Address: SHARON M OLIVER, P.O. BOX 1045, ELIZABETH, CO, 80107, US

(73) Assignee: Sharon Marie Oliver, Elizabeth, CO (US)

(21) Appl. No.: 10/907,421

(22) Filed: Mar. 31, 2005

(51) Int. Cl. A01K 97/10

(52) U.S. Cl. 43/21.2

(57) ABSTRACT

A fishing pole holder for use with a lawn chair or similar tubular structure that consists of two clamps attached to a horizontal bar that attaches to an arm or leg of the chair. This horizontal bar bends down at a 90-degree angle and is designed with a swivel joint and thumbscrew for adjusting and tightening this section at an angle. There is a 90 degree angle perpendicular to this and is angled back 25 degrees. The next section is angled forward horizontally and twisted with two ½″ radii to support the handle of a fishing pole.

A fishing pole holder designed for the arm or leg of a lawn or other portable chair. This invention is simple and portable as swell as durable. It is attachable and adjustable at any position and works well on the arm or the tubular legs of a lawn chair on the dock or the bank of a fishing spot. It is our intention for an inexpensive fishing pole holder and does not require any tools to attach it.

### BACKGROUND OF THE INVENTION

1. Field of the Invention

This devise is for fishing poles and is attachable to the armrest or legs of a lawn chair or other portable chairs.

2. Description of the Prior Art

A Search was conducted to uncover devises used on portable chairs and the inventions most pertinent were found as follows:
i. U.S. Pat. No. 4,819,903 issued to Jimenez, a cylindrical attachment.
ii. U.S. Pat. No. 4,877,165 issued to Behrle, Oct. 31, 1989 with tubular receptacle.
iii. U.S. Pat. No. 4,270,724 issued to McMullen, Jun. 1981 with cup holder, and ashtray.
iv. U.S. Pat. No. 5,964,439 issued to Johnson Oct. 12, 1999 for wheelchair.
   Two of the Patents, U.S. Pat. Nos. 4,819,903 and 5,964,349, while being attachable to a chair's tubular structure, I feel is not a versatile as this devise.
U.S. Pat. No. 4,877,165 is designed for a boat gunwale.
U.S. Pat. No. 4,270,724 contains cup holder and ashtray making it somewhat cumbersome.

Most of the referenced design art is tubular or cylindrical attachments for holding the fishing poles and may hinder usage of some types of pole handles.

### BRIEF DESCRIPTION OF THE DRAWINGS

FIG. 1: View from the front side of the device.

FIG. 2: View from the right side of the device.

FIG. 3: View of the backside of the device.

FIG. 4: View from the top of the device.

FIG. 5: View from a left angle of the device.

FIG. 6: Exploded view of all parts of the device.

FIG. 7: Relationship of the device to a chair and Fishing Pole.

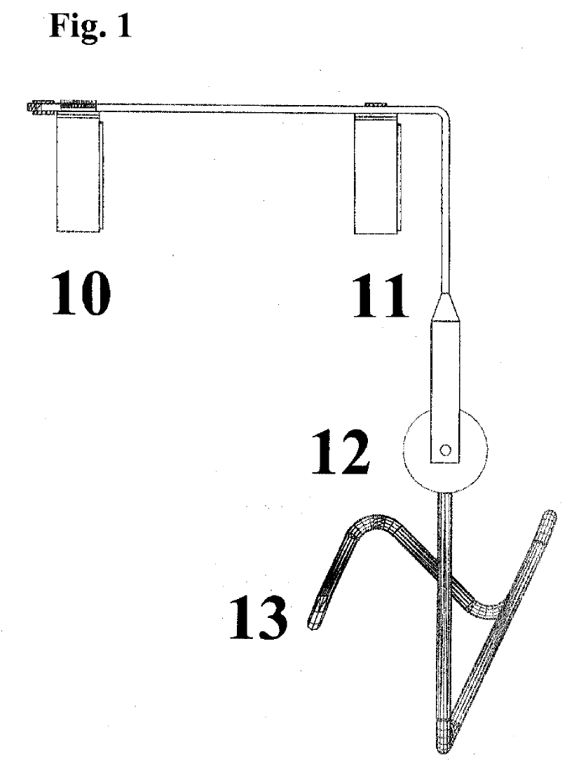

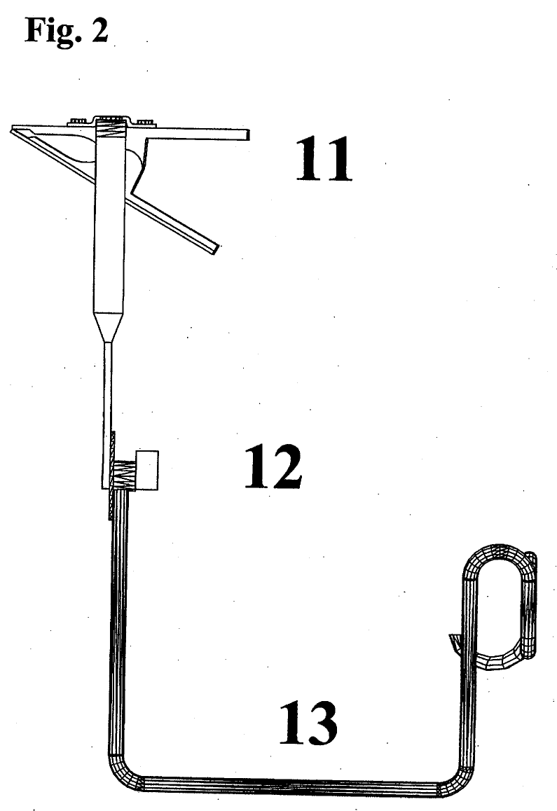

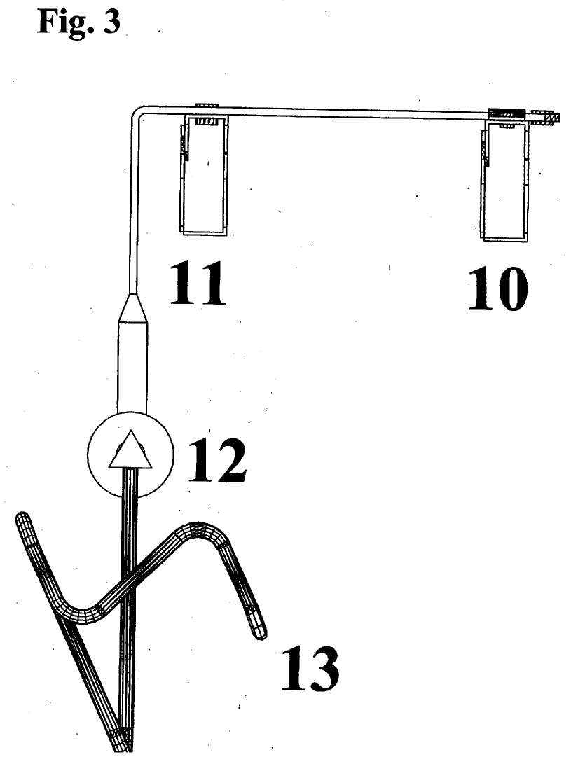

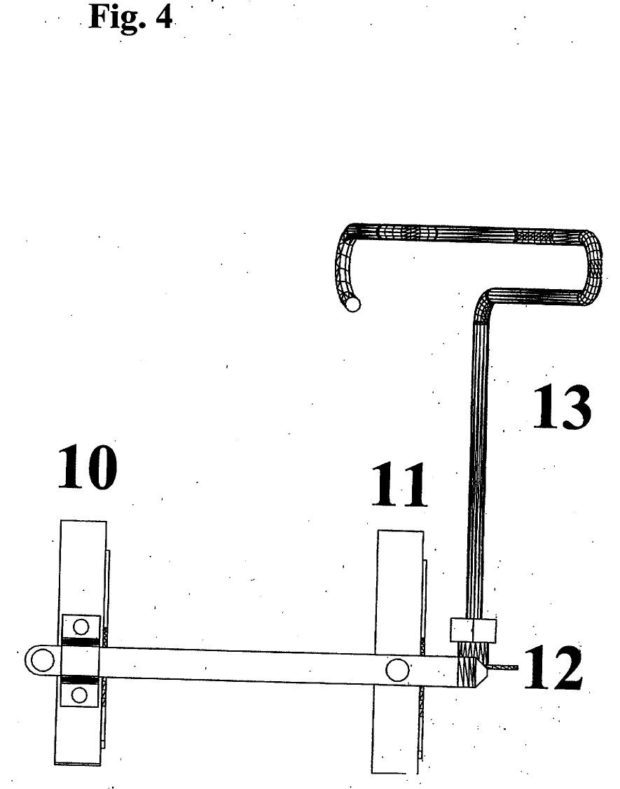

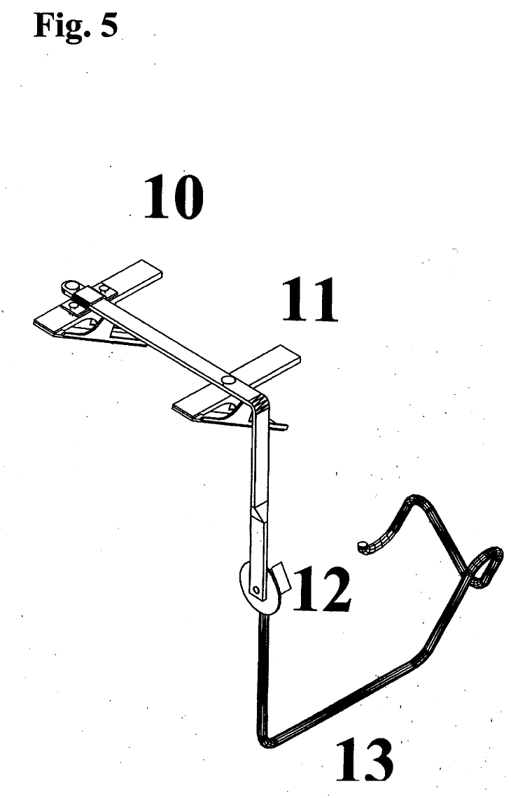

Reference: 10 For FIGS. 1-5 adjustable attachment clamp

Reference: 11 For FIGS. 1-5 stationary attachment clamp

Reference: 12 For FIGS. 1-5 Swivel joint with thumbscrew for adjustment forward or back

Reference: 13 For FIGS. 1-5 Section of device angled back 25 degrees and bent wire framing to hold pole handle.

### DESCRIPTION OF THE PREFERRED EMBODIMENT

The clamp 11 is attached to arm or leg of chair and clamp 10 is then adjusted to the proper position and holds the device securely to the chair.

The swivel 12 is then adjusted to the correct angle for the fishing pole and tightened using the thumbscrew.

Said invention is a simple and reliable clamping devise for fishing pole holder that is adjustable and provides for having the pole sit at any angle.

There are various changes and modification which may be made to the invention as would be apparent to those skilled in the art when confronted with this invention, and are intended to fall within the spirit of the present invention which is limited only by the scope of the claims appended hereto.

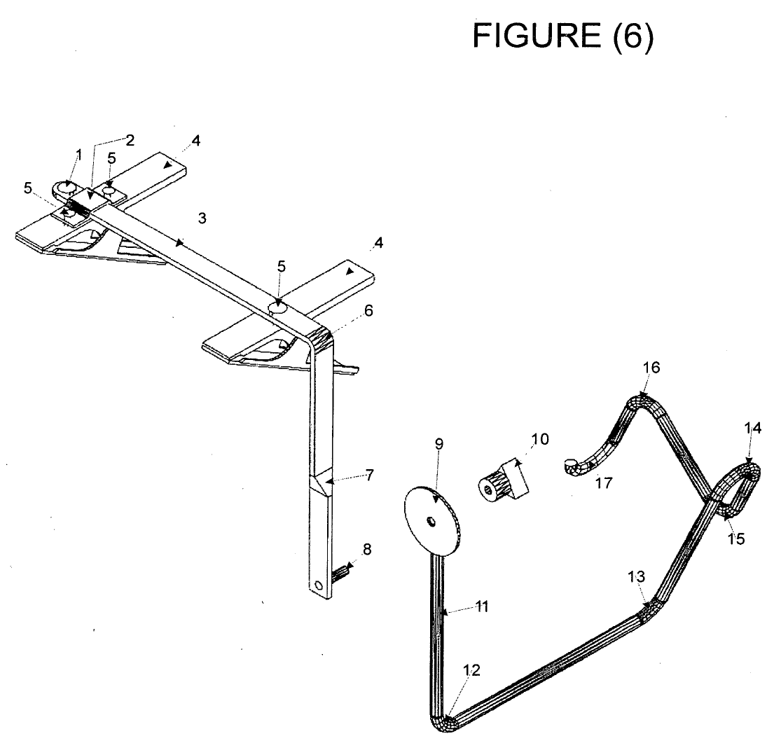

Referring to FIG. 6 the fishing pole holder is comprised of a ½″ wide by ⅛″ thick and about 12-½″ long flat steel bar (3) bent at 90 degrees (6) downward at about 7″ from end and twisted 90 degrees (7) about 3″ from the bend (6) with a 10-24 stud permanently attached (8) about 3″ from the twist (70. Two 1″ spring clamps (4) that are held close by spring pressure are mounted under the flat steel bar (3) along the 7″ side with one clamp (4) permanently attached with a rivet (5) at about 1½″ from the bend (6) with the other clamp attached on the under side of the flat steel bar(3) by means of a bracket (2) that is riveted (5) to the clamp (4) at the end of the flat steel bar (3) this will allow the clamp (4) to be able to slide back and forth along the 7″ side of the steel bar (3). A 10-32 screw (1) is placed in the end of the 7″ side of the steel bar (3) in order to keep the clamp 4 with the bracket (2) from sliding off the steel bar (3).

Also referring to FIG. 6 the fishing pole holder is comprised of a ¼″ diameter steel rod that is 23″ long (11) that has a ¼″ finder washer that is 1½″ outside diameter (9) permanently attached to one end of the ¼″ rod. About 3″ from the washer (9) is a bend (12) that moves the rod horizontal about 5″ to bend (13) that moves perpendicular 5″ to bend (14) that is 180 degrees with a diameter of 1¼″ that moves 2½″ to bend (15) that is 80 degrees and bent adjacent to the rod between bend (13) and bend (14) that moves 3½″ to bend (16) that is bent downward 80 degrees and moves down perpendicular to the rod between bends (13) and (14) for 2″ to bend (17) which is bent inward toward the Dole holder for 180 degrees with a diameter of 1¼″.

The rod (11) and the bar (3) are held together by placing the washer (9) over the 10-24 stud (80 and tighten down with the thumbscrew (10).

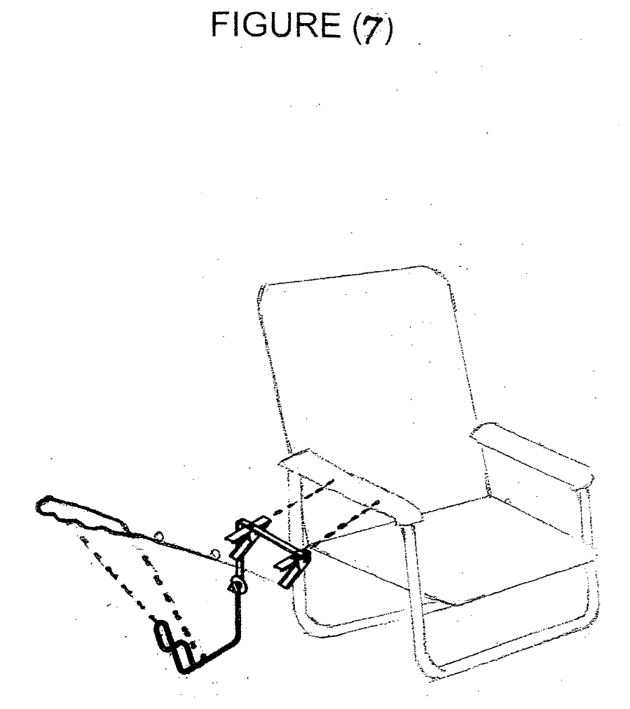

Referring to FIG. 7 shows the relationship for the pole holder to a chair and fishing pole.

1. A Fishing pole holder for the use on a lawn chair or other portable chair, comprised of:
a horizontal support bar having two 1″ spring clamps with one spring clamp fastened permanently to the underside of a flat support bar at the bent end by means of a rivet and the second spring clamp is fastened to the other end of the support bar by means of a metal strap riveted to the top of the spring clamp straddling the support bar with the clamp underneath allowing the clamp to slide freely as to be adjustable for fastening to the arm of a chair or any available area it will clamp upon with a screw at the end to prevent the adjustable clamp from sliding off.
an extension of the support bar is bent downward at a 90 degree angle then twisted 90 degrees while continuing downward and terminating with a permanently attached ¼-20 stud.
a washer is permanently fastened to a rod which extends downward from the washer and the rod is then angled horizontal then perpendicular and finally forward with the washer now being fastened to the ¼-20 stud with a thumbscrew to allow adjustment in a forward or backward angle.
a plurality of bending curves in the forward angle of the device is in such a way that the pole will be held solidly and is easily retrievable.

2. A fishing pole holder for a fishing rod with the handle at the rear end of the pole comprising:
a multiple set of curves twisted at varying degrees and circumferences of the metal rod to provide adjustability to hold the fishing rod at an angle convenient to the user with the ability of being able to remove the fishing rod quickly.

3. The fishing rod holder of claim 2 is formed by attachment to a flat horizontal bar for stability of movement with spring clamps for the holding of said horizontal bar to a surface and constructed of a metal rod for the convenient method of bending curves for holding the rod handle.
